(19) United States
(12) Patent Application Publication
(10) Pub. No.: US 2016/0381061 A1
(43) Pub. Date: Dec. 29, 2016

(54) PROXY FOR MITIGATION OF ATTACKS EXPLOITING MISCONFIGURED OR COMPROMISED WEB SERVERS

(71) Applicant: CHECK POINT SOFTWARE TECHNOLOGIES LTD., TEL AVIV (IL)

(72) Inventors: Oded VANUNU, Rishon Lezion (IL); Liad MIZRACHI, Petach Tikva (IL); Roi PAZ, Kadima (IL); Avi GIMPEL, Jerusalem (IL); Dikla BARDA, Zoran (IL)

(21) Appl. No.: 14/752,955

(22) Filed: Jun. 28, 2015

(51) Int. Cl. H04L 29/06; H04L 29/08

(52) U.S. Cl. CPC H04L 63/1433; H04L 67/02; H04L 63/166; H04L 63/0281

(57) ABSTRACT

Methods and systems for preventing cyber-attacks on web sessions are disclosed. These methods and systems comprise elements of hardware and software for intercepting a Hyper Text Transfer Protocol (HTTP) transaction; analyzing the HTTP headers of the intercepted HTTP transaction for web session vulnerabilities; and, based on the result of analyzing the HTTP headers of the intercepted HTTP transaction for web session vulnerabilities, inserting at least one HTTP protocol element into the series of HTTP headers of the HTTP transaction.

### TECHNICAL FIELD OF THE INVENTION

The present invention relates to methods and systems for preventing cyber-attacks that attempt to exploit vulnerabilities in web applications.

### BACKGROUND

The exponential growth of web applications exposes users to numerous web vulnerabilities (including exploits such as clickjacking, cross-site scripting, and many more) as well as new potential attack vectors. These vulnerabilities may result from malicious or compromised web servers, a misconfigured web server, or bugs in web applications. Web attacks take advantage and focus on these vulnerabilities. Should the attacks be successful, the web client or web browser or components associated therewith, both hardware and software may be compromised, damaged. Moreover, attacks based on these vulnerabilities serve as an entrypoint to damage unprotected components, servers, computers, and the like, in the target computer's network, and cause even more extensive damage.

### SUMMARY OF THE INVENTION

The present invention discloses an inspection/proxy device that modifies (in real time) the output of compromised or misconfigured web servers as well as the output of inadequately debugged web application code so as to protect the users.

Web servers and web applications may accidentally or intentionally behave in ways which enable attacks or exploits on the web session (ie. exploits directed against the browser or other web client; or directed against the server).

The invention provides systems and methods and systems for identifying Hyper Text Transfer Protocol (HTTP) headers sent by the server and client. The systems employ logic to determine, for example, whether a particular header or header attribute (or lack thereof) potentially creates a security vulnerability. Should there be a security vulnerability, the system takes protective action.

For example, if a vulnerability to Cross-Site Scripting attacks is discovered, the proxy, for example, inserts a “X-XSS-Protection” HTTP header in an HTTP Response to turn on a browser's cross-site scripting filter.

If a vulnerability to, for example, clickjacking attacks, is discovered, the proxy, for example, inserts a “X-Frame-Options” HTTP header in an HTTP Response to prevent the content from being framed in a manner which enables exploits.

If a vulnerability to, for example, attacks in which a user downloads a seemingly non-executable file which later becomes executable, is discovered, the proxy, for example, inserts a “X-Content-Type-Options” HTTP header in an HTTP Response so that the browser will not switch content types.

If a vulnerability to, for example, Secure Socket Layer (SSL) stripping attacks, is discovered, the proxy, for example, checks a policy repository for the particular web site, and, for example, inserts a “Strict-Transport-Security” HTTP header to ensure that the browser only accesses the website via secure connections.

If a vulnerability to, for example, sidejacking attacks, is discovered, the proxy, for example, inserts a “Secure” attribute in an HTTP “Set-Cookie” header transmitted, for example, over a Transport Layer Security (TLS) connection. This ensures that the browser will transmit the cookie only over a secure connection.

If a vulnerability to, for example, malicious applets or other malware that tries to access sensitive data is discovered, the proxy, for example, inserts a “HttpOnly” attribute in an HTTP “Set-Cookie” header.

If a disclosure of implementation-related data is discovered and this disclosure is determined to be unnecessary, the proxy, for example, deletes the header that discloses the implementation-related data.

If a vulnerability in the server to, for example, illegal data transmitted from a client in an unanticipated character set is discovered, the proxy, for example, inserts the Accept-Charset header into an HTTP Request.

This document references terms that are used consistently or interchangeably herein. These terms, including variations thereof, are as follows:

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application”, includes executable software, and optionally, any graphical user interfaces (GUI), through which certain functionality may be implemented.

The term “linked” as used herein includes both wired or wireless links, either direct or indirect, and placing the computers, including, servers, components and the like, in electronic and/or data communications with each other.

The term “HTTP transaction” as used herein refers to a request or a response belonging to the Hyper Text Transaction (HTTP) protocol.

Embodiments of the present invention are directed to a method, which is computer-implemented, for preventing cyber-attacks on web sessions. The method comprises: intercepting a Hyper Text Transfer Protocol (HTTP) transaction; analyzing the HTTP headers of the intercepted HTTP transaction for web session vulnerabilities and, based on the result of analyzing the HTTP headers of the intercepted HTTP transaction for web session vulnerabilities, inserting at least one HTTP protocol element into the series of HTTP headers of the HTTP transaction.

Embodiments of the present invention are directed to a computer system for preventing cyber-attacks on web sessions. The computer system comprises: a storage medium for storing computer components; and a computerized processor for executing the computer components. The computer components comprise: a first computer component for intercepting a Hyper Text Transfer Protocol (HTTP) transaction; a second computer component for analyzing the HTTP headers of the intercepted HTTP transaction for web session vulnerabilities; and, a third computer component for based on the result of analyzing the HTTP headers of the intercepted HTTP transaction for web session vulnerabilities, inserting at least one HTTP protocol element into the series of HTTP headers of the HTTP transaction.

Embodiments of the present invention are directed to a computer-usable non-transitory storage medium having a computer program embodied thereon for causing a suitable programmed system for preventing unauthorized use of a DNS channel, by performing the following steps when such program is executed on the system. The steps comprise: intercepting a Hyper Text Transfer Protocol (HTTP) transaction; analyzing the HTTP headers of the intercepted HTTP transaction for web session vulnerabilities; and, based on the result of analyzing the HTTP headers of the intercepted HTTP transaction for web session vulnerabilities, inserting at least one HTTP protocol element into the series of HTTP headers of the HTTP transaction.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram illustrating a system environment in which an embodiment of the invention is deployed;

FIG. 2 is a diagram of the architecture of an exemplary Web Application Hardening Proxy embodying the invention;

FIG. 3 is a flow diagram illustrating the process executed by the HTTP Proxying Module for the Network Interface to WAN;

FIG. 4 is a flow diagram illustrating the process executed by the HTTP Proxying Module for the Network Interface to Data Center;

FIG. 5 is a flow diagram illustrating the process executed by the HTTP Header Modification Module for HTTP Requests;

FIG. 6 is a flow diagram illustrating the first process executed by the HTTP Header Modification Module for HTTP Responses; and,

FIG. 7 is a flow diagram illustrating the second process executed by the HTTP Header Modification Module for HTTP Responses.

### DETAILED DESCRIPTION OF THE INVENTION

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

The present invention may be embodied in a system, method or computer program product. Accordingly, aspects of the present invention may take the form of an entirely hardware embodiment, an entirely software embodiment (including firmware, resident software, micro-code) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

The invention is described in detail and exemplarily for a packet processing gateway (termed the “Web Application Hardening Proxy”) which all web traffic passing between a web server and web client. However the invention may also be embodied, for example, in a software module residing inside a stateful inspection firewall. Alternatively, the invention may be embodied, for example, in a standalone gateway in a network lacking a stateful inspection firewall (for example a network residing behind a Network Address Translation function). Alternatively, the invention may, for example, be embodied in a virtual server residing in a cloud computing environment, or in a number of servers residing behind a load distribution device.

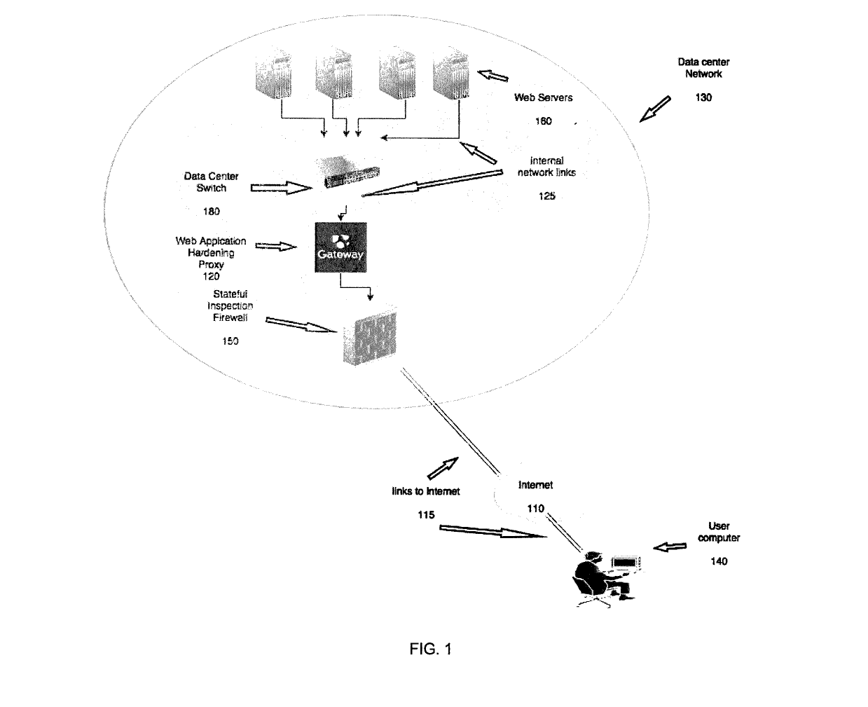

FIG. 1 depicts a system environment in which an embodiment of the invention is deployed. A user accesses, for example, web sites and web applications hosted on Web Servers 160 via a web browser located on the User Computer 140. User Computer 140 is linked to a Link to Internet 115, which in turn is linked to, for example, the Internet 110. The Web Servers 160 are located, for example, in a Data Center Network 130. The Web Servers 160 linked to Internal Network Links 125, which are also linked to, for example, a Data Center Switch 180. The Web Application Hardening Proxy 120 is also linked to, for example, the Data Center Switch 180 and, for example, all traffic between the Web Servers 160 and User computer 140 passes through the the Web Application Hardening Proxy 120. The Web Application Hardening Proxy 120 is linked to, for example, a Stateful Inspection Firewall 150 which demarcates the edge of the Data Center Network 130. The Stateful Inspection Firewall 150 is also linked to the Links to Internet 115.

Alternatively, the Web Application Hardening Proxy 120 may be placed, for example, outside of the Data Center Network 130 and linked to the Internet 110.

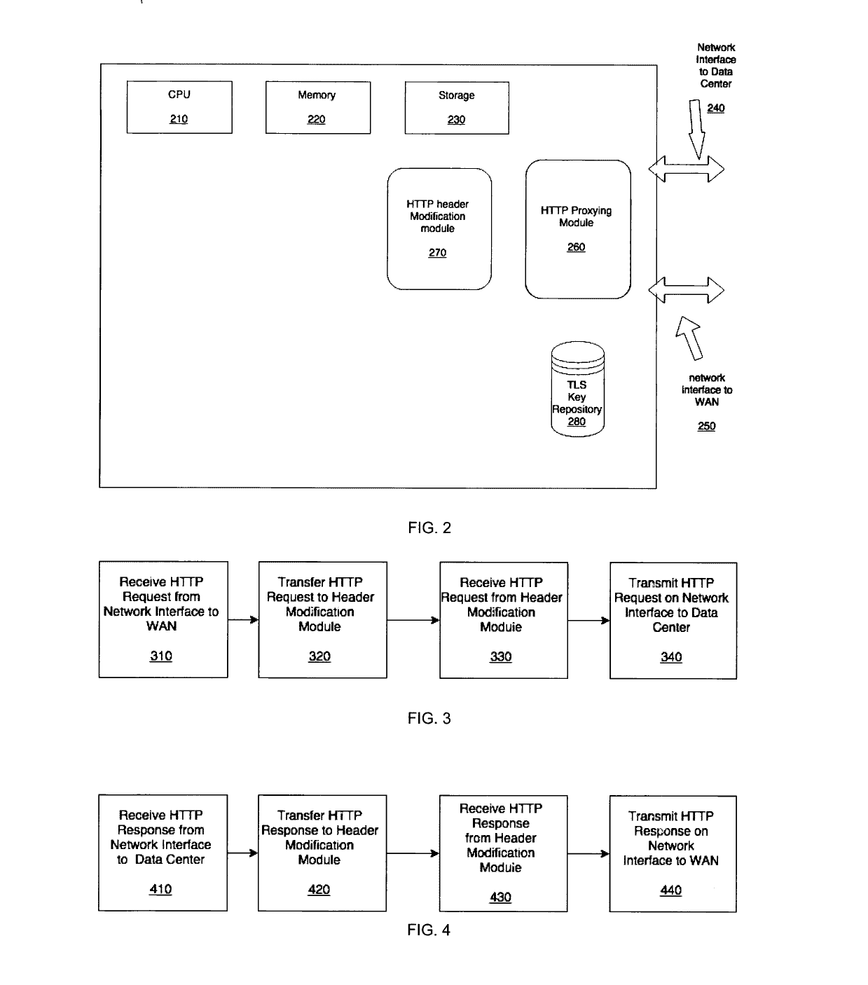

FIG. 2 is a depiction of the internal architecture of the Web Application Hardening Proxy 120. The Web Application Hardening Proxy 120 includes a central processing unit (CPU) 210 formed of one or more processors, electronically connected, including in electronic and/or data communication with Memory 220, Storage 230, Network Interface to Data Center 240 and Network Interface to Wide Area Network (WAN) 250, Hyper Text Transfer Protocol (HTTP) Proving Module 260, HTTP Header Modification Module 270, and Transport Layer Security (TLS) Key Repository 280.

The Central Processing Unit (CPU) 210 is formed of one or more processors, including physical or virtual microprocessors, for performing the Web Application Hardening Proxy 120 functions and operations including, for example controlling the memory 220, storage 230, Network Interface to Data Center 240 and Network Interface to Wide Area Network (WAN) 250, Hyper Text Transfer Protocol (HTTP) Proxying Module 260, HTTP Header Modification Module 270, and Transport Layer Security (TLS) Key Repository 280 along with the processes shown in FIGS. 3, 4, 5, 6, and 7. The processors are, for example, conventional processors, such as those used in servers, computers, and other computerized devices. For example, the processors may include x86 Processors from AMD and Intel, Xeon® and Pentium® processors from Intel, as well as any combinations thereof.

The Memory 220 is any conventional memory media. The Memory 220 stores machine executable instructions associated with the operation of the components, including, Network Interface to Data Center 240 and Network Interface to Wide Area Network (WAN) 250, Hyper Text Transfer Protocol (HTTP) Proxying Module 260, HTTP Header Modification Module 270, and Transport Layer Security (TLS) Key Repository 280 and all instructions for executing the processes of FIGS. 3, 4, 5, 6, and 7 and detailed herein. The processors of the CPU 210, Memory 220, and Storage 230 although each shown as a single component for representative purposes, may be multiple components, and may be outside of the Web Application Hardening Proxy 120, and linked to the Data Center Network 130 or Internet 110.

The Network Interface to Data Center 240 is a physical, virtual, or logical data link for communication with the nodes linked to the Data Center Network 240. Similarly, the Network Interface to WAN 250 is a physical, virtual, or logical data link for communication with nodes external to the Data Center Network 240 such as, for example, computers linked to the Internet 110.

The HTTP Proxying Module 260 reads packet traffic from, for example, the Network Interface to WAN 150 and intercepts, for example, HTTP Requests directed to specific Web Servers 160 from User Computers 140. The HTTP Proxying Module 260 similarly reads packet traffic from, for example, the Network Interface to Data Center 140, and intercepts, for example, HTTP Responses transmitted from specific Web Servers 160 to User Computers 140.

The HTTP Proxying Module 260 performs the interception of HTTP Requests and Responses by using, for example, a proxying method such as transparent proxying, explicit proxying, or the like. For example, if the Web Application Hardening Proxy 120 is utilizing transparent proxying, the HTTP Proxying Module 260 masquerades as the Web Server 160 in its packet exchanges with the User Computer 140, and masquerades as the User Computer 140 in its packet exchanges with the Web Server 160. Alternatively, if the Web Application Hardening Proxy 120 is utilizing explicit proxying, then the User Computer 140 specifies the Internet Protocol (IP) address of the Web Application Hardening Proxy 120 as the destination of its packets.

In the case of data sent between the Web Server 160 and the User Computer 140 that is encrypted using, for example, Transport Layer Security (TLS), the HTTP Proxying Module 260, for example, makes use of keys from the TLS Key Repository 280 to decrypt the HTTP requests and responses after reception and re-encrypt the possibly-modified requests and responses before transmission.

After intercepting an HTTP request, the HTTP Proxying Module 260 presents the HTTP Request to the HTTP Header Modification Module 270 for further processing, After processing by the HTTP Header Modification Module 270, the HTTP Proxying Module 260 receives, for example, the possibly modified HTTP request and, for example, transmits the HTTP Request to the Web Server 160. Details of the HTTP Proxying Module 260 process for handling HTTP Requests appears below, with reference to FIG. 3.

After intercepting an HTTP response, the HTTP Proxying Module 260 presents the HTTP Response to the HTTP Header Modification Module 270 for further processing. After processing by the HTTP Header Modification Module 270, the HTTP Proxying Module 260, for example, receives the possibly modified HTTP response and, for example, transmits the HTTP Response to the User Computer 140. Details of the HTTP Proxying Module 260 process for handling HTTP responses appears below, with reference to FIG. 4.

The HTTP Header Modification Module 270 receives HTTP requests and responses from, for example, the HTTP Proxying Module 260. The HTTP Header Modification Module 270 inspects the series of HTTP headers in the HTTP request or HTTP response and, for example, possibly modifies the series of HTTP headers to mitigate web security vulnerabilities. The HTTP Header Modification Module 270 then passes the possibly modified HTTP request or response back to the HTTP Proxying Module 260. Details of the HTTP Header Modification Module 270 processes appear below, with reference to FIG, 5, 6 and 7.

FIG. 3 depicts the process performed by the HTTP Proxying Module 260 to handle HTTP Requests received by the Web Traffic Hardening Proxy 120, and originating at a User Computer 140 for a Web Server 160. At block 310, the process receives an HTTP request from, for example, the Network Interface to WAN 250. It may do this, for example, by reading packets from the Network Interface to WAN 250 via a software socket interface until a complete HTTP request has been received. At block 320, the process transfers the HTTP Request to, for example, the HTTP Header Modification Module 270 for vulnerability mitigation. After the HTTP Header Modification Module 270 completes its processing, the process receives the possibly modified HTTP Request at block 330. At block 340, the process transmits the HTTP Request on the Network Interface to Data Center 240. The HTTP Request then arrives at, for example, the target Web Server 160.

FIG. 4 depicts the process performed by the HTTP Proxying Module 260 to handle HTTP Responses received by the Web Traffic Hardening Proxy 120, and originating at a Web Server 160 for a User Computer 140. At block 310, the process receives an HTTP response from, for example, the Network Interface to WAN 250. It may do this, for example, by reading packets from the Network Interface to WAN 250 via a software socket interface until a complete HTTP Response has been received. At block 320, the process transfers the HTTP Response to, for example, the HTTP Header Modification Module 270 for vulnerability mitigation. After the HTTP Header Modification Module 270 completes its processing, the process receives the possibly modified Response at block 330. At block 340, the process transmits the HTTP Response on the Network Interface to WAN 250. The Response then arrives at, for example, the target User Computer 140.

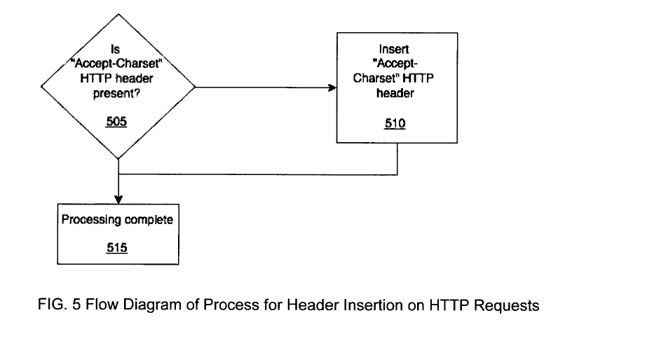

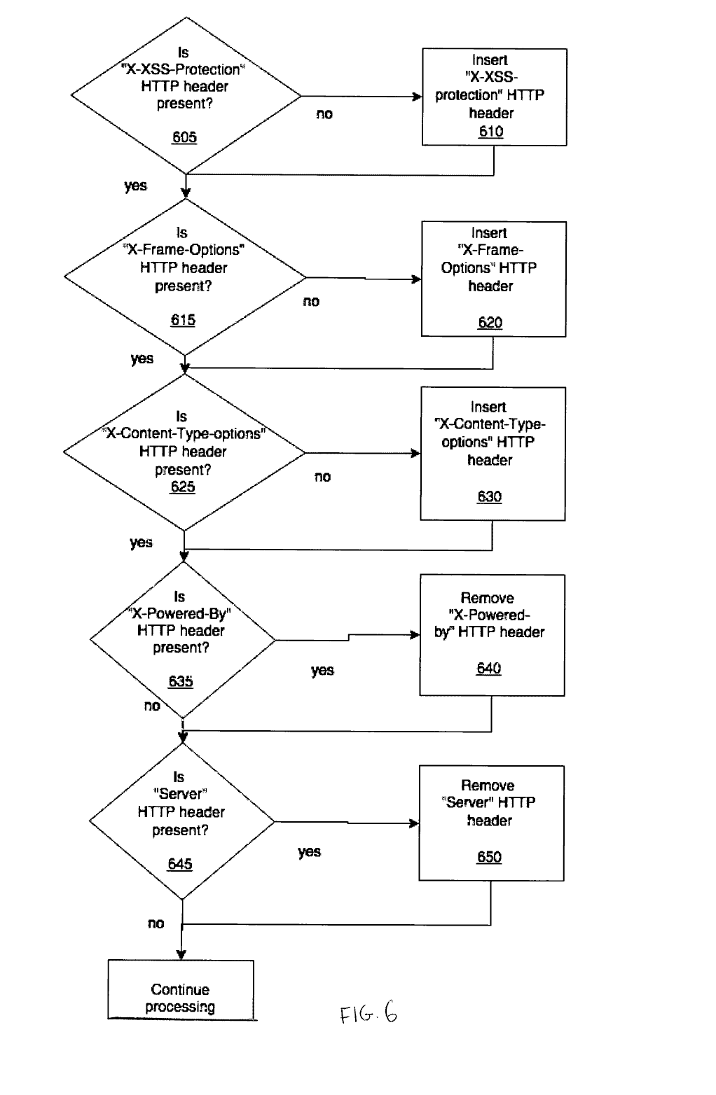

FIG. 5 depicts the process performed by the Header Modification Module 270 on HTTP Requests. At block 505, the process inspects the series of HTTP headers in the HTTP Response to determine if the Accept-Charset header is present. If there is no Accept-Charset header, then at block 510 the header is inserted, specifying, for example, Unicode Transformation Format-8 (UTF-8) as the supported character set. The insertion of the Accept-Charset header protects, for example, the Web Server 160 from attacks which transmit malicious data using a non-standard encoding so as to bypass the server's input validation. At block 515 processing of the HTTP Request is complete, and the HTTP Header Modification Module 270 proceeds with other processing such as, for example, transmitting the HTTP Request to the Web Server 160.

FIG. 6 depicts the process performed by the Header Modification Module 270 on HTTP Responses. At block 605, the process inspects the series of HTTP headers in the HTTP Response to determine if the X-XSS-Protection header is present This header instructs the browser on the User Computer 140 to turn on the Cross Site Scripting filter, which protects the user from, for example, Cross Site Scripting attacks. If there is no X-XSS-Protection header, then at block 610 the header is inserted.

At block 615, the process inspects the series of HTTP headers in the HTTP Response to determine if the Response includes an X-Frame-Options header. This header instructs the browser on the User Computer 140 that it is always or sometimes prohibited to display this web data within a display frame. Instructing the browser in this manner protects the user from, for example, clickjacking attacks. If there is no X-Frame-Options header, then at block 620 the header is inserted specifying, for example, that framing the web data is always prohibited. Alternatively, an embodiment may insert an X-Frame-Options header that permits framing the web data only if the framing data originates at the same site as the framed content.

At block 625, the process inspects the series of HTTP headers in the HTTP Response to determine if the Response includes an X-Content-Type-Options header with, for example, the value of “nosniff”. This header instructs the browser on the User Computer 140 not to use Multipurpose Internet Mail Extensions (MIME) headers in the downloaded content to change the downloaded content type. Instructing the browser in this manner protects the user from, for example, attacks where a malicious or compromised website invites the user to download a text file and then uses MIME headers to instruct the browser to run the downloaded content as an executable file. If there is no X-Content-Type-Options header with the value of “nosniff”, then at block 630 the header is inserted.

At block 635, the process inspects the series of HTTP headers in the HTTP Response to determine if the Response includes an X-Powered-By header. This header includes, for example, information about the application framework (eg. JBoss) that a web application is using. This header is, for example, not necessary, but the disclosed information may, for example, enable an attacker to exploit a vulnerability of the particular application framework. If the X-Powered-By header is present, then at block 640 the header is deleted.

At block 645, the process inspects the series of HTTP headers in the HTTP Response to determine if the Response includes a Server header. This header includes, for example, information about the server type (eg. Apache) that a web application is using. This header is, for example, not necessary, but the disclosed information may, for example, enable an attacker to exploit a vulnerability of the particular server implementation. If the Server header is present, then at block 650 the header is deleted.

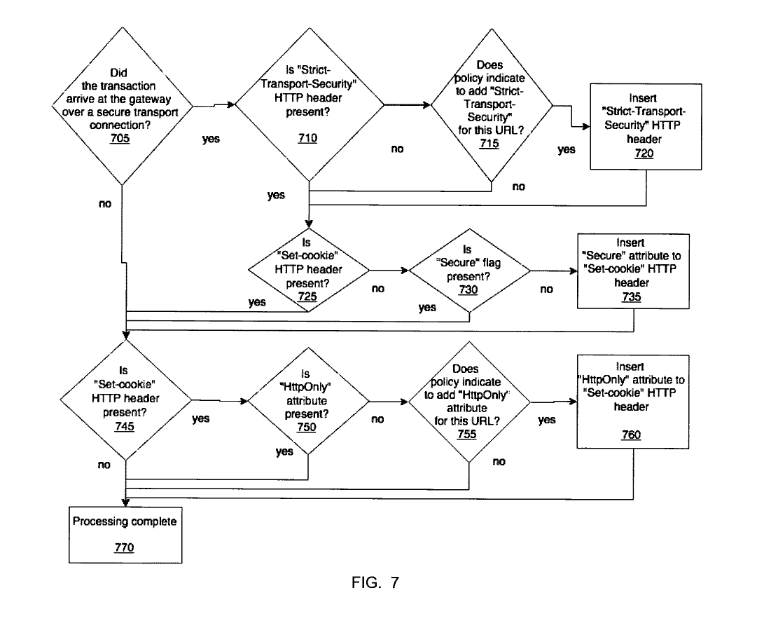

At block 655, the process terminates, and control proceeds, for example, to the second process for handling HTTP Responses (illustrated in FIG. 7).

FIG. 7 depicts the second process performed by the Header Modification Module 270 for handling HTTP responses. At block 705, the process determines whether the HTTP Response arrived on a TLS connection. If so, the control proceeds to block 710, which begins processing that relates to special characteristics of secured HTTP traffic. At block 710, the process checks if a Strict-Transport-Security HTTP header is present. This header informs the browser that in the future only authenticated traffic should be accepted for this website. By sending this header, the server protects the browser from, for example, SSL stripping attacks. If the Strict-Transport-Security HTTP header is absent, then at block 715 the process, for example, consults local policy to see if the hardening proxy functionality requires the process to insert the Strict-Transport-Security HTTP header for this specific URL. If so, then at block 720 the processing inserts the Strict-Transport-Security HTTP header including, for example, max-age, subdomain, and preload attributes as indicated by local policy.

For an HTTP response received on a TLS connection, following the termination (at whatever stage) of the Strict-Transport-Security HTTP header processing, control passes to block 725, which examines whether a Set-Cookie HTTP header is present. If so, then at block 730 the process, for example, examines whether the Secure flag is present in the Set-Cookie HTTP header. The presence of the Secure attribute instructs the browser to transmit the cookie only on TLS connections, thus preventing potential attackers from being able to snoop the cookie while in transit (as might be done in preparing a sidejacking attack). If the Secure flag is not present, then at block 735 the process, for example, inserts the Secure flag to the Set-Cookie HTTP header. For any HTTP response (whether received on a TLS connection or not), control proceeds to block 745, which again checks whether a Set-Cookie HTTP header is present. If so, control proceeds to block 750, which determines if the HttpOnly flag is present in the Set-Cookie HTTP header. The presence of the HttpOnly flag signals to the browser that the cookie should not be made available to client-side scripts (which may potentially include malware). At block 755, the process, for example, consults local policy to determine whether, for example, the hardening proxy functionality requires the process to insert the HttpOnly flag for the cookie for this specific URL. If so, then at block 760, the process inserts the HttpOnly flag to the Set-Cookie HTTP header. At block 770 processing completes and the HTTP Header Modification Module, for example, transfers the possibly modified HTTP Response to the HTTP Proxy Module 260 for transmission to the User Computer 140.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing ructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments.

The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed. to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for preventing cyber-attacks on web sessions, comprising:
intercepting a Hyper Text Transfer Protocol (HTTP) transaction;
analyzing the HTTP headers of the intercepted HTTP transaction for web session vulnerabilities; and,
based on the result of analyzing the HTTP headers of the intercepted HTTP transaction for enabling web session vulnerabilities, inserting at least one HTTP protocol element into the series of HTTP headers of the HTTP transaction.

2. The method of claim 1, additionally comprising:
transmitting the modified HTTP transaction.

3. The method of claim 1, additionally comprising, subsequent to analyzing the HTTP headers of the intercepted HTTP transaction for web session vulnerabilities:
consulting a policy regarding modification of HTTP headers in HTTP responses according to requested Uniform Resource Locators (URLs); and,
based on the result of the consulting a policy regarding modification of HTTP headers in HTTP responses according to requested URLs, and based on the result of analyzing the HTTP headers of the intercepted HTTP transaction for web session vulnerabilities, inserting at least one HTTP protocol element into the series of HTTP headers of the HTTP transaction.

4. The method of claim 1, wherein the intercepting an HTTP transaction is from a Transport Layer Security (TLS) connection.

5. The method of claim 1, wherein the inserting at least one HTTP protocol element into the series of HTTP headers of the HTTP transaction includes inserting a “X-XSS-Protection” HTTP header.

6. The method of claim 1, wherein the inserting at least one HTTP protocol element into the series of HTTP headers of the HTTP transaction includes inserting a “X-Frame-Options” HTTP header.

7. The method of claim 1, wherein the inserting at least one HTTP protocol element into the series of HTTP headers of the HTTP transaction includes inserting a “X-Content-Type-Options” HTTP header.

8. The method of claim 1, wherein the inserting at least one HTTP protocol element into the series of HTTP headers of the HTTP transaction includes inserting a “Strict-Transport-Security” HTTP header.

9. The method of claim 1, wherein the inserting at least one HTTP protocol element into the series of HTTP headers of the HTTP transaction includes inserting a “Accept-Charset” HTTP header.

10. The method of claim 1, wherein the inserting at least one HTTP protocol element into the series of HTTP headers of the HTTP transaction includes inserting the “HttpOnly” attribute to a “Set-Cookie” HTTP header.

11. The method of claim 1, wherein the inserting at least one HTTP protocol element into the series of HTTP headers of the HTTP transaction includes inserting the “Secure” attribute to a “Set-Cookie” HTTP header.

12. The method of claim 8, additionally comprising, prior to inserting the “Strict-Transport-Security” HTTP header:
determining whether the HTTP Response was received over a TLS connection; and,
according to whether the whether the HTTP Response was received over a TLS connection, inserting the “Strict-Transport-Security” HTTP header.

13. The method of claim 11, additionally comprising, prior to inserting the “Secure” attribute to the “Set-Cookie” HTTP header:
determining whether the HTTP Response was received over a TLS connection; and,
according to whether the HTTP Response was received over a TLS connection, inserting the “Secure” attribute to the “Set-Cookie” HTTP header.

14. A method for preventing of cyber-attacks on web servers, comprising:
intercepting a Hyper Text Transfer Protocol (HTTP) transaction;
analyzing the HTTP headers of the intercepted HTTP transaction for disclosing implementation-related information; and,
according to the result of analyzing the HTTP headers of the intercepted HTTP transaction for disclosing implementation-related information, deleting implementation-disclosing HTTP headers from the HTTP transaction.

15. The method of claim 14, wherein the reducing the server's vulnerability to attacks, by deleting implementation-disclosing HTTP headers from the HTTP transaction includes deleting the “Server” HTTP header.

16. The method of claim 14, wherein the reducing the server's vulnerability to attacks, by deleting implementation-disclosing HTTP headers from the HTTP transaction includes deleting the “X-Powered-By” HTTP header.

17. A computer system for prevention of cyber-attacks on web sessions, comprising:
a storage medium for storing computer components; and
a computerized processor for executing the computer components comprising:
a first computer component for intercepting a Hyper Text Transfer Protocol (HTTP) transaction;
a second computer component for analyzing the HTTP headers of the intercepted HTTP transaction for web session vulnerabilities; and,
a third computer component for based on the result of analyzing the HTTP headers of the intercepted HTTP transaction for web session vulnerabilities, inserting at least one HTTP protocol element into the series of HTTP headers of the HTTP transaction.
